(19) United States
(12) Patent Application Publication
(10) Pub. No.: US 2013/0162193 A1
(43) Pub. Date: Jun. 27, 2013

(54) SOLAR CHARGING ASSEMBLY

(71) Applicant: PowerFilm, Inc., Ames, IA (US)

(72) Inventors: Trent D. Quick, Huxley, IA (US); Frank Jeffrey, Ames, IA (US)

(73) Assignee: POWERFILM, INC., Ames, IA (US)

(21) Appl. No.: 13/690,677

(22) Filed: Nov. 30, 2012

Related U.S. Application Data
(60) Provisional application No. 61/579,071, filed on Dec. 22, 2011.

(51) Int. Cl. H02J 7/00

(52) U.S. Cl. CPC H02J 7/0042
USPC 320/101

(57) ABSTRACT

A solar charging assembly has an elongated body with a first end and a second end. The first end has a first roller element with an inlet port and the second end has a second roller element with an outlet port. A solar sheet extends from the elongated body and a fastening member extends from the solar sheet. The fastening member fits around the elongated body to hold the solar sheet in a releasable rolled up position.

### CROSS REFERENCE TO RELATED APPLICATION

This application claims the benefit of U.S. Provisional Application No. 61/579,071 filed Dec. 22, 2011.

### BACKGROUND OF THE INVENTION

This invention relates to battery chargers. More specifically this invention relates to a solar powered battery charger for charging the battery of handheld devices.

Individuals utilize handheld devices more and more every day. Specifically, devices such as cell phones, IPads®, SmartPhones, MP3 Players, Tablets and E-Readers and the like are utilized in ordered for individuals to communicate with others, have access to the internet, for reading purposes, listening to music and the like. In order to keep the size of these devices small so that they can fit into an individual's pocket or purse the batteries associated with such devices typically have a limited life source. As a result, these handheld devices must periodically be charged by plugging a cord into the handheld device that is electrically connected to an electrical outlet in order to charge the battery.

A problem occurs in that finding an electrical outlet is not always simple. For example, when an individual goes camping for several days they are not by any electrical outlets in order to be able to charge their cell phones. Alternatively, when power outages occur or an individual is in a situation where they cannot access an electrical outlet, such as when a vehicle breaks down on the side of the highway, alternative means to powering up are desired. In addition, over time utilizing utility company provided electricity in order to power up your phone can increase utility bills and have negative impact on the environment.

As a result of these requirements, solar powered battery chargers have been provided as can be seen in U.S. patent application Ser. Nos. 12/952,810 and 12/985,047 that are incorporated herein. The '810 and '047 applications disclose flexible solar panels that are able to provide a charge for a battery. However, the size of the solar panel is not conducive to charging a handheld device. In addition, the bulk and size of the solar panel make carrying the charger difficult and undesired. Thus, a need in the art exists for an improved charging device that will overcome the deficiencies in the art.

An objective of the present invention is to provide a solar charging assembly that is compact and easy to carry.

Another objective of the present invention is to provide a solar charging assembly capable of charging handheld devices in remote areas.

These and other objectives will be apparent to one of ordinary skill in the art based upon the following written description, drawings, and claims.

### BRIEF SUMMARY OF THE INVENTION

A solar charging assembly has an elongated body with a first end and a second end. The first end has a first roller element with an inlet port and the second end has a second roller element with an outlet port. A solar sheet extends from the elongated body and a fastening member extends from the solar sheet. The fastening member fits around the elongated body to hold the solar sheet in a releasable rolled up position.

### BRIEF DESCRIPTION OF THE DRAWINGS

FIG. 1 is a perspective view of a solar charging assembly; and

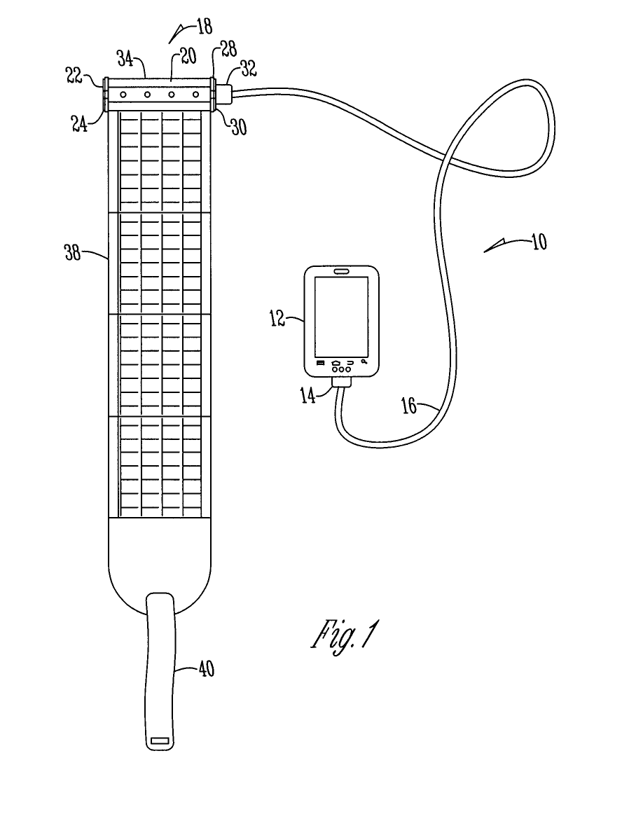

FIG. 2 is a top plan view of a solar charging assembly.

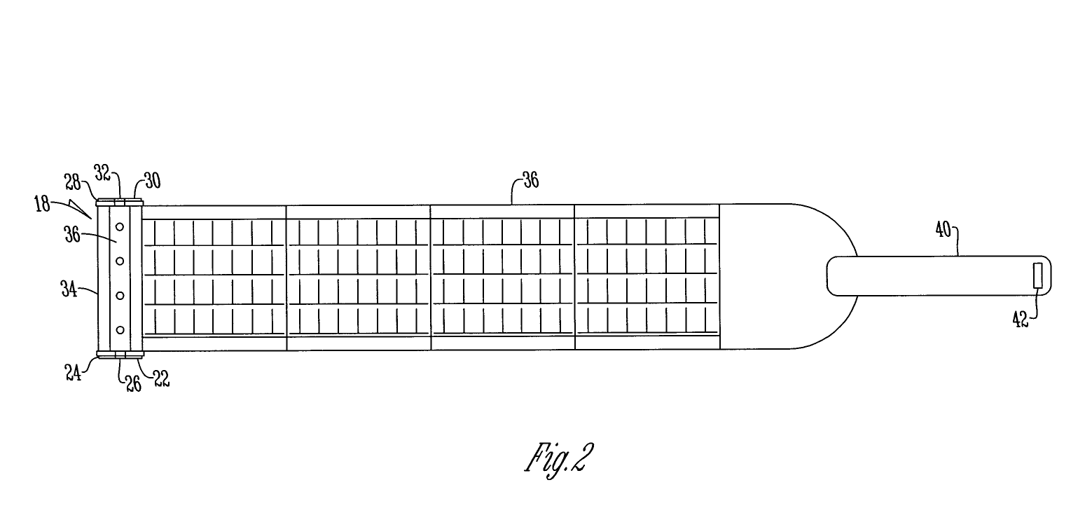

### DESCRIPTION OF THE PREFERRED EMBODIMENT

The figures show a charging assembly 10 utilized in association with a handheld device 12 such as a power tablet E-Reader, cell phone, SmartPhone, MP3 Player or the like that has a port 14 that can receive a power cable 16 in order to recharge the battery of the handheld device 12. The cable 16 electrically connects the port 14 of the handheld device 12 to a charging device 18.

The charging device 18 has a charging body 20 that extends from a first end 22 having a first roller element 24 that includes an input port 26 and extends to a second roller element 28 at a second end 30 that has an output port 32 wherein an elongated body 34 is disposed therebetween and houses a battery 36 or charge storage device. Thus, the charge cable 16 electrically connects to the output port 32 of the second roller 28 in order to convey electricity to the handheld device 12 to charge the battery of the handheld device 12.

Extending from the elongated body 34 is a solar sheet 38 that comprises a plurality of solar cells as is taught in U.S. patent application Ser. Nos. 12/985,047 and 12/952,180. The solar sheet 38 comprises a flexible lightweight material that is able to convert light into electrical energy and is electrically connected to the battery 36 or charge storage device within the elongated body of the charging device. The solar sheet 38 is comprised of weather resistant fabric and does not have to be sun soaked to operate.

A fastening element 40 extends from the solar sheet 38 and has an attachment member 42 such as a hook and loop, button or the like thereon such that when the solar sheet 38 wraps around the elongated body 34 the fastening element 40 extends around the rolled up solar sheet 38 to hold the solar sheet 38 in the rolled up position in between the first and second roller elements 24, 28. The distance between the first and second roller elements 24, 28 preferably is around 4.25 inches and in a preferred embodiment is less than five inches. In this manner when the charging device 18 is rolled up the device is able to fit into an individual's pocket or easily within a purse.

In operation, when an individual needs to charge their handheld device 12 the charging device 18 can be taken out of a pocket or a purse and unrolled and exposed to a light source such as the sun. The solar sheet 38 then converts the energy from the light into electrical energy that is transmitted to the battery 36 or charge storage device within the elongated body 34 of the charging device 18. A power cable 18 can then be connected to the outlet port 32 of the second roller element 28 to convey electricity to the handheld device 12 for charging of the battery of the handheld device 12. If needed, the input port 26 can receive a secondary charger (not shown) that may be plugged into an electrical device or a car cigarette light or the like in order to provide an additional source of electricity to the battery 36 or charge storage device within the elongated body 34. Once the handheld device 12 has been charged the solar sheet 38 is rolled up onto the elongated body 34 and the fastening element 40 is wrapped around the rolled up solar sheet 38 and fastened to itself or alternatively the solar sheet 38 to hold the charging device 18 in a bundle minimizing the size of the charging device 18.

Thus provided is a charging device 18 for charging a handheld device 12. The charging device 18 is lightweight, has weather resistant fabric, and easily rolls for storage and unrolls for use. The charging device 18 fits easily into bags and pockets and weighs less than one pound and is very durable for the harshest of environments. In addition, the charging device 18 does not need to be sun soaked after storage and instead can provide critical power immediately when placed into the sun. Thus, at the very least all of the stated problems have been overcome.

What is claimed is:

1. A solar charging assembly, comprising:
an elongated body having a first end and a second end;
a solar sheet extends from the elongated body; and
a fastening element extends from the solar sheet and wraps around the elongated body to hold the solar sheet in a releasable rolled up position.

2. The assembly of claim 1 wherein the first and second ends have first and second roller elements.

3. The assembly of claim 1 wherein the first end has an inlet port and the second end has an outlet port.

4. The assembly of claim 1 wherein the fastening element includes an attachment member.
